(19) United States
(12) Patent Application Publication
(10) Pub. No.: US 2013/0209831 A1
(43) Pub. Date: Aug. 15, 2013

(54) High-Strength, Cold-Formable Steel and Flat Steel Product Made from Such a Steel

(71) Applicants: Jens-Ulrik Becker, Duisburg (DE); Sinasi Göklü, Hattingen (DE); Harald Hofmann, Dortmund (DE); Christian Höckling, Duisburg (DE); Matthias Schirmer, Dusseldorf (DE); Ingo Thomas, Duisburg (DE)

(72) Inventors: Jens-Ulrik Becker, Duisburg (DE); Sinasi Göklü, Hattingen (DE); Harald Hofmann, Dortmund (DE); Christian Höckling, Duisburg (DE); Matthias Schirmer, Dusseldorf (DE); Ingo Thomas, Duisburg (DE)

(73) Assignee: THYSSENKRUPP STEEL EUROPE AG, Duisburg (DE)

(21) Appl. No.: 13/807,808

(22) PCT Filed: Jul. 1, 2011
(86) PCT No.: PCT/EP11/61154

§ 371 Date: Mar. 13, 2013

(30) Foreign Application Priority Data
Jul. 2, 2010 (EP) 10168353.0

(51) Int. Cl. C22C 38/38; C22C 38/22; C22C 38/26; C22C 38/32; C22C 38/28; B32B 15/01; C22C 38/42; C22C 38/44; C22C 38/48; C22C 38/50; C22C 38/54; C22C 38/20; C22C 38/58

(52) U.S. Cl. CPC C22C 38/38; C22C 38/20; C22C 38/22; C22C 38/26; C22C 38/32; C22C 38/28; C22C 38/58; C22C 38/42; C22C 38/44; C22C 38/48; C22C 38/50; C22C 38/54; B32B 15/013; B32B 15/012
USPC 428/653; 420/74; 420/73; 428/659

(57) ABSTRACT

High-strength, cold-formable steel and a flat steel product produced from such a steel, in which an optimal combination of weldability and a low tendency towards delayed cracking is ensured along with good strength and hot and cold deformability. In order to achieve this, a steel according to the invention contains (in % by weight) C: 0.1-1.0%, Mn: 10-25%, Si: up to 0.5%, Al: 0.3-2%, Cr: 1.5-3.5%, S: <0.03%, P: <0.08%, N: <0.1%, Mo: <2%, B: <0.01%, Ni: <8%, Cu: <5%, Ca: up to 0.015%, at least one element from the group “V, Nb” with the following proviso: Nb: 0.01-0.5%, V: 0.01-0.5% and optionally Ti: 0.01-0.5% and iron and unavoidable, production-related impurities as the remainder.

The invention relates to a high-strength, cold-formable steel with a high manganese content, which exhibits good resistance to hydrogen-induced delayed cracking and particularly good weldability. The invention additionally relates to flat steel products produced from such a steel.

Hydrogen-induced “delayed cracking” is caused by hydrogen penetrating the steel material from outside. In contrast, the term “delayed fracture” is used when the failure of the steel material is caused by hydrogen that is present in the material as a result of production.

The aforementioned combination of properties is required in particular of steels which are used to manufacture body components for motor vehicles. In that field specifically, there is a need for the metal sheets from which the components are manufactured not only to be easily deformable while having an optimally low weight but also to exhibit sufficient strength in order to contribute effectively, at small sheet thicknesses, to the stability of the body in question.

In the case of steels intended for body components and comparable uses, it must also be ensured that they are easily weldable and in particular do not tend to crack in the region of the respective weld spot during the welding process (“solder brittleness”).

The term “solder brittleness” refers to a weakening of grain boundaries due to a medium infiltrating the grain boundaries (e.g. zinc from a coating, Cu from a welding additive), which can lead to cracks as a result of cooling stresses. For example, when welding galvanised metal sheets, it may happen that the zinc applied as an anti-corrosion coating to the sheet steel substrate melts due to the high welding temperatures and penetrates the steel sheet at grain boundaries. During the subsequent cooling, stresses occur at these grain boundaries and said stresses can cause intercrystalline cracks.

Finally, even after a long period of use under the loads that occur during practical use, and despite multiple cold forming that may be necessary in order to shape the component in question, steels used for body components should not tend to form hydrogen-induced cracks, so-called “delayed cracking”, which could bring dangerous consequences in terms of the strength and stability of the component and of the body produced therewith.

For body construction and similar fields of use, many attempts have been made to provide steels which exhibit good deformability and mechanical properties that are optimised with regard to the intended use.

A first example of such a lightweight steel is described in WO 2007/075006 A1. Besides Fe and unavoidable impurities, the steel presented therein contains (in % by weight) 0.2-1.5% C, 10-25% Mn, 0.01-3.0% Al, 0.005-2.0% Si, up to 0.03% P, up to 0.03% S and up to 0.040% N and in each case optionally 0.1-2.0% Cr, 0.0005-0.01% Ca, 0.01-0.1% Ti, 0.001-0.020% B. The steel thus alloyed is said to exhibit an optimal deformability while having a high degree of toughness, high strength and a reduced susceptibility to cracking. In addition, it is said to be particularly easy to coat with an anti-corrosion coating.

Another steel that is said to have an optimised deformability, strength and weldability is known from WO 93/13233 A1. Besides iron and unavoidable impurities, this steel contains (in % by weight) up to 1.5% C, 15-35% Mn, 0.1-6.0% Al, and in each case optionally up to 0.6% Si, up to 5% Cu, up to 1% Nb, up to 0.5% V, up to 0.5% Ti, up to 9% Cr, less than 4.0% Ni and less than 0.2% N. In WO 93/13233 A1, the optional addition of up to 9% by weight Cr is ascribed an austenite-stabilising and strength-increasing effect. Ni, Ti and V contents in the known steel are said to have the same effect. In the examples of embodiments which are stated as being according to the invention in WO 93/13233 A1 and which contain appreciable Cr contents in combination with Nb, Ti or V contents, at the same time in each case high Al contents of more than 3% by weight are provided. In WO 93/13233 A1, Al in contents of 0.1-6.0% by weight is regarded as being particularly important in respect of the austenite stabilisation, the cold workability and press deformability.

WO 2007/074994 A1 likewise describes a steel for uses in the automobile manufacturing sector, said steel being said to exhibit a high degree of toughness and strength. Besides iron and unavoidable impurities, this steel contains (in % by weight) 0.1-1.5% C, 5-35% Mn, 0.01-3% Al, and in each case optionally less than 3% Si, less than 9% Cr, less than 5% Cu, less than 4% Ni, less than 1% Mo, less than 1% Nb, less than 0.5% V and less than 0.04% N. The steel may also contain optionally Sn, Sb, As and Te in contents of in each case 0.005-0.05%, B, La and Ce in contents of in each case 0.0005-0.040%, Zr and Ti in contents of in each case 0.0005-0.1% and Ca in contents of 0.0005-0.03%. The toughness of the steel is said to be improved by the presence of Al in contents of 0.01-3.0% by weight since Al stabilises the ferrite component of the steel and suppresses the development of ε-martensite. The known steel may contain up to 3% by weight Si in order to improve the tensile strength of the steel. In this case, the Si content is limited to at most 3% by weight in order to avoid surface defects and to ensure good weldability. The known steel may contain Cr in order to improve the corrosion resistance of the steel and to ensure the good deformability thereof. The known steel may contain Nb and V in order to optimise the strength. However, none of the examples of embodiments presented in WO 2007/074994 A1 contains contents of Cr in combination with appreciable contents of Al, Nb or V.

A steel with high Mn contents is also known from WO 95/26423 A1, said steel being said to have an improved workability. Besides iron and unavoidable impurities, this steel contains (in % by weight) less than 1.5% C, 15-35% Mn, 0.1-6% Al and at least one of the elements Si, Cu, Nb, V, Cr, Ni, N, B, Ti, Zr, La, Ce or Ca with the proviso that the Si content is max. 0.6%, the Cu content is max. 5%, the Nb content is max. 1.0%, the V content is max. 0.5%, the Cr content is max. 9.0%, the Ni content is max. 4.0%, the N content is max. 0.2% and the B content is 0.0005-0.04%, the Ti and Zr content is in each case 0.0005-0.050%, the La and Ce content is in each case 0.005-0.040% and the Ca content is 0.0005-0.030%. The effects of the individual alloying elements, as described in WO 95/26423, correspond to the effects explained in the documents discussed above.

EP 2 090 668 A1 likewise discloses alloying instructions for a steel which, in a manner comparable to the steels explained above, comprises besides iron and unavoidable impurities (in % by weight) 0.05-0.78% C, 11-23% Mn and may contain in each case up to 5% Al and Cr, up to 2.5% Ni, up to 5% Si and up to 0.5% V. According to the examples of embodiments indicated in EP 2 090 668 A1, in each case either a high Al content is combined with a low Cr content or a high Cr content is combined with a low Al content. Although the strength-increasing effect of V is mentioned in the description of EP 2 090 668 A1, none of the examples of embodiments contains this or any other micro-alloying element.

Finally, WO 2009/084792 A1 describes a steel with high Mn contents which, besides iron and unavoidable impurities, contains (in % by weight) 0.3-0.9% C, 15-25% Mn, 0.01-2.0% Si, 0.01-4.0% Al, up to 0.05% S, up to 0.1% P and at least one element from the group Nb, V, Ti, W, Mo, Cr with the proviso that the Nb content is less than 0.2%, the V content is less than 0.5%, the Ti content is less than 0.3% and the W, Mo and Cr content is in each case less than 1%. The presence of Ti is said to improve the weldability of this known steel. In contrast, the Cr content is limited to max. 1% because higher Cr contents are said to have no strength-increasing effect and thus would lead only to an increase in the alloy costs.

Against the background of the prior art summarised above, the problem addressed by the invention was that of providing a steel and flat steel products produced therefrom in which an optimal combination of weldability and a low tendency to the delayed formation of cracks is ensured while exhibiting good strength and hot and cold deformability.

With regard to the steel, this problem has been solved according to the invention by a steel composed according to claim 1.

With regard to the flat steel product, the invention solution to the aforementioned problem lies in the teaching of claim 13.

Advantageous embodiments of the invention are indicated in the dependent claims and will be explained in detail below along with the general concept of the invention.

Therefore, besides iron and unavoidable, production-related impurities, a high-strength, cold-formable steel according to the invention contains (in % by weight) 0.1-1.0% C, 10-25% Mn, up to 0.5% Si, 0.3-2% Al, 1.5-3.5% Cr, <0.03% S, <0.08% P, <0.1% N, <2% Mo, <0.01% B, <8% Ni, <5% Cu, up to 0.015% Ca, and at least one element from the group “V, Nb” with the proviso that the respective Nb content is 0.01-0.5% and the respective V content is 0.01-0.5%, and optionally 0.01-0.5% Ti.

The steel according to the invention and accordingly also flat products made from the steel according to the invention, such as steel sheets or strips, have an austenitic structure and may exhibit TWIP and TRIP properties.

The C content of at least 0.1% by weight, in particular at least 0.3% by weight, in the steel according to the invention helps to stabilise the austenitic structure thereof. The TWIP and TRIP properties of the steel can also be influenced in a targeted manner via the respective C content thereof since carbon increases the stacking fault energy. The presence of C according to the invention also increases the strength without leading to a loss of ductility. However, C contents of more than 1% by weight can lead to a reduction in the deformability of the steel according to the invention. The C content thereof is therefore limited to 0.1-1% by weight. The desired effect of the carbon content can be achieved particularly reliably in the steel according to the invention when the C contents thereof are limited to a range from 0.1-0.5% by weight, in particular 0.3-0.5% by weight.

In a manner known per se, manganese brings about the required high strength and a higher stacking fault energy in the steel according to the invention. The TRIP or TWIP properties of the steel according to the invention can therefore be set via the Mn contents. In addition, the presence of high Mn contents ensures that the steel according to the invention has the desired austenitic structure. This effect is achieved in a particularly reliable manner if the Mn content is at least 10% by weight. In the case of Mn contents above 25% by weight, there is no substantial further improvement with regard to the properties of interest here. Instead there is the risk that the maximum tensile strength decreases at higher manganese contents.

With regard to the susceptibility to delayed cracking, lower Mn contents prove to be particularly advantageous in combination with the Al and Si contents defined according to the invention. For example, a Mn content of less than 23% by weight, in particular up to 22% by weight, leads to a considerable reduction in the corrosion potential and counteracts hydrogen absorption. The lowering of the Mn content is limited at the lower end of the scale by an associated worsening of the ease with which the steel is produced and of the workability thereof. Therefore, in a steel according to the invention, the Mn content is limited to a range from 10-25% by weight, in particular 17-25% by weight, the effects used according to the invention being achieved in a particularly reliable manner with an Mn content in the range of up to 22% by weight.

At the contents defined according to the invention, Al and Si increase the corrosion resistance and reduce the tendency towards delayed cracking. Welding tests have also shown that in steels according to the invention the risk of solder brittleness and hot brittleness is reduced in comparison to known alloying concepts if the Al and/or Si content is kept within the ranges defined according to the invention. Thus, if according to the invention the aluminium content is limited to 0.3-2% by weight and the Si content is max. 0.5% by weight, a weldability of the steel according to the invention is ensured which is superior to that of steels with a high manganese content having higher Al and Si contents. In this case, the Al and Si contents are limited so that the risk, which would otherwise exist with high Al and Si contents, of excessively small operating ranges during the resistance spot welding is countered. The effects achieved by the presence of Si and Al in combination according to the invention can be utilised in a particularly reliable manner when the Al content is 0.5-1.5% by weight, in particular 0.5-1.3% by weight, and the Si content is 0.2-0.5% by weight.

In a steel according to the invention, particular importance is assigned to the presence of Cr in contents of 1.5-3.5% by weight. Cr keeps the corrosion potential at a low level, so that the steel according to the invention has a high resistance to delayed cracking. In addition, Cr forms precipitates with the carbon and nitrogen present in the steel, and said precipitates counteract the delayed cracking by accumulating hydrogen. To this end, a steel according to the invention preferably contains a Cr content of at least 1.7% by weight, in particular at least 1.8% by weight. The upper limit of the Cr content is limited to at most 2.5% by weight, in particular at most 2.2% by weight. The upper limit for the Cr content as defined according to the invention ensures on the one hand that no relatively large quantities of Cr carbides form that would impair the mechanical properties (strength/elongation at break relationship). At Cr contents below the limit defined according to the invention, on the other hand, Cr has no further reducing effect on the tendency towards delayed cracking.

The steel according to the invention contains at least one of the micro-alloying elements vanadium and niobium, as a result of which the conditions for an optimal fine grain size of the structure of flat steel products (sheet, strip) made from the steel according to the invention are put in place. V and Nb allow the generation of a superfine-crystalline structure having a high density of V and/or Nb precipitates (VC, VN, VCN, NbC, NbN, NbCN, VNbC, VNbN, VNbCN) and a high resistance to solder cracking. The size of the grains obtained in this way in a steel according to the invention is considerably smaller than in the case of the austenitic steels with a high manganese content that are currently on the market. Thus, for a flat steel product (sheet, strip) cold-rolled from the steel according to the invention, it is possible to guarantee a structural fineness which corresponds to at least ASTM 13 and is generally finer than ASTM 14. It has been able to be demonstrated using practical tests that the fine grain size of a flat steel product according to the invention regularly corresponds to at least ASTM 14, with an ever finer structure which meets the requirement of ASTM 15 being obtained in most cases.

However, the steel according to the invention cannot only be further processed in the cold-rolled state but rather is also suitable for further processing as a hot-rolled flat steel product. Since the thickness of such hot-rolled products (sheet, strip) is generally greater than that of cold-rolled flat steel products, solder cracks that may occur in the region of weld spots weaken hot-rolled flat steel products to a lesser extent than on the cold strip. What is important here is the ratio between crack length and material thickness. In many cases, therefore, it is sufficient if, in the case of a hot-rolled flat steel product according to the invention which is fed without additional cold rolling for further processing to produce a component, the grain is not as fine as in the case of a cold-rolled sheet or strip according to the invention. The grain size sufficient for hot-rolled products according to the invention is therefore defined as ASTM 11 or finer, it also being possible of course to achieve a finer structure corresponding to ASTM 12 or more.

The particularly fine structure achieved by the alloy according to the invention results in the desired optimal combination of weldability and low tendency towards delayed cracking while exhibiting good strength and hot and cold deformability. This applies equally to hot and cold strip produced from the steel according to the invention. Particular emphasis must be placed on the solder brittleness-minimising effect of the fine structure, which can be reproduced with optimal operational reliability as a result of the composition according to the invention.

The positive effects of Nb and V on the fine grain size of the structure of a steel composed according to the invention can be utilised when vanadium or niobium are in each case present alone or in combination with one another in the steel according to the invention.

A first variant of the steel according to the invention therefore contains at least 0.01% by weight to 0.5% by weight niobium and at most traces of vanadium which can be attributed to the impurities and are thus ineffective from an alloying point of view.

In contrast, a second variant of the alloy according to the invention has Nb contents which are at most on the impurity scale, while the fine grain size of the structure that is provided according to the invention is ensured by vanadium contents of at least 0.01% by weight and at most 0.5% by weight.

In a third variant of the invention, vanadium and niobium are present in combination in the steel according to the invention, wherein the contents of said elements in total is in each case at least 0.01% by weight but does not exceed 0.5% by weight.

The effects achieved according to the invention as a result of the presence of Nb and/or V are obtained in a particularly reliable manner when the sum of the contents of Nb and V in a steel alloyed according to the invention is 0.03-0.3% by weight, in particular more than 0.05% by weight.

As a micro-alloying element in the steel according to the invention, titanium likewise forms precipitates which contribute to the fine grain size and can have a positive effect on the mechanical properties of the steel. However, with regard to achieving a fine-grain structure, titanium is less effective than the alloying elements niobium or vanadium which are added for this purpose according to the invention. An effect of titanium in the steel according to the invention that optimally supports the effect of said elements is achieved at Ti contents of at least 0.01% by weight. At excessively high Ti contents, coarse TiC particles may form, from which cracks may start during the cold rolling and cold forming of flat products made from the steel according to the invention. In addition, the TiC particles may be destroyed during the cold rolling and cold forming. When this happens, cavities appear between the destroyed particles and said cavities can once again serve as a starting point for cracks. Finally, coarse TiC particles close to the surface may lead to defects on the surface during the cold rolling and cold forming. The invention therefore provides to keep the Ti content, if present at all, below an upper limit of 0.5% by weight. If steels according to the invention are to be produced with optimised combinations of properties, this can be achieved by reducing the Ti content of the steel according to the invention to values at which Ti no longer has any effect and the remaining Ti content can be attributed to unavoidable impurities.

The Nb and Ti contents that may optionally be present in the steel according to the invention lead to Nb and Ti precipitates as early as during the hot rolling and thus increase the rolling resistance during the hot and cold rolling. This may prove to be unfavourable particularly during the hot rolling since the relatively high Al and Si contents prescribed according to the invention already entail an increased hot rolling resistance. In contrast, the fine vanadium precipitates do not appear until during the final annealing of the finished rolled sheet and therefore do not hinder the hot and cold rolling. In cases where it proves difficult to hot or cold roll the steel according to the invention, it may for this reason be advantageous to increase the vanadium content of the steel in relation to the Nb content or to omit the addition of niobium and/or titanium in favour of a high vanadium content.

Nb, V and Ti all have an effect on delayed cracking. As known per se, these three elements form precipitates at which the hydrogen is “trapped” (i.e. held) and rendered harmless.

However, only by adding Nb and/or V according to the invention can a very fine-grain structure (ASTM 13, in particular ASTM 14 and finer) be reliably achieved in a steel having a high manganese content.

Sulphur and phosphorus unavoidably enter the steel according to the invention during the steelmaking process but can lead to an embrittlement at the grain boundaries. Particularly with regard to a sufficient hot deformability, therefore, the S content is limited to less than 0.03% by weight and the P content is limited to less than 0.08% by weight in the steel according to the invention.

Nitrogen in contents of up to 0.1% by weight is necessary in order to form carbonitrides. If there is an N deficiency, C-rich and N-poor carbonitrides form. Nevertheless, the N content should be set low. Al and N form precipitates which can considerably impair the mechanical properties, in particular the elongation values. The AlN precipitates can no longer be dissolved, even by a subsequent heat treatment. For this reason, the maximum nitrogen content in the steel according to the invention is limited to less than 0.1% by weight, an optimal effect of the nitrogen in the steel according to the invention being achieved when the N content thereof is limited to 0.0030-0.0250% by weight, in particular 0.005-0.0170% by weight.

Mo in effective contents of less than 2% by weight also helps to improve the corrosion resistance and thus in an associated manner also helps to further reduce the risk of delayed cracking. Like Cr, Mo additionally forms precipitates with the carbon and nitrogen present in the steel, which precipitates counteract the delayed cracking by accumulating hydrogen.

In terms of its effect on the mechanical-technological properties, boron substitutes the alloying element Mn. For instance, it has been found that a steel having an Mn content of 20% by weight and 0.003% boron has a similar property profile to a steel which contains 25% Mn but no B. Therefore, while maintaining equally high strengths, the addition of up to 0.01% by weight boron to a steel alloy according to the invention allows reduced Mn contents which are advantageous with a view to avoiding delayed cracking and solder brittleness. In addition, small contents of boron have a positive effect on the strip edge quality of the hot strip produced from a steel according to the invention. Cracks and instabilities in the strip edge region, as are known from Al- and Si-alloyed steels having high manganese contents, are in this way suppressed.

Ni may optionally be added to a steel according to the invention. Nickel contributes to a high elongation at break and increases the toughness of the steel. In steels according to the invention, however, this effect is reduced if the steel contains more than 8% by weight nickel. The upper limit of the nickel contents optionally added according to the invention is therefore limited to 8% by weight, in particular 5% by weight.

Moreover, by adding copper in contents of less than 5% by weight, in particular less than 3% by weight, the hardness of a steel according to the invention can be increased due to the formation of precipitates. However, Cu contents of more than 5% by weight can cause surface defects which may for example render unusable the flat products (strip, sheet) produced from the steel according to the invention.

As a result, therefore, the invention provides a steel which has not only a high strength of at least 800 MPa and more but in which also a high resistance to delayed cracking is combined with a high resistance to “solder brittleness”.

The steel according to the invention is highly suitable for processing to form flat steel products, such as steel sheets or steel strips, which are subsequently to be subjected to hot or cold deformation in order to create components.

In order to protect the flat steel products according to the invention against surface corrosion, they may be coated with a metal protective coating at least on their surface that is exposed to a corrosive attack during practical use. In a manner known per se, this protective coating may be an Al- or Zn-based layer which is applied to the flat product according to the invention for example by electrolytic galvanisation, by hot-dip galvanisation, by galvannealed coatings, ZnNi coatings or by hot-dip aluminisation, wherein good coating results can be achieved in particular by electrolytic galvanisation.

Flat steel products produced according to the invention are generally characterised by a particularly high energy absorption capacity in the event of a suddenly occurring load.

Due to their particular range of properties, flat steel products produced in the manner according to the invention are particularly suitable for the production of body components. Due to its extraordinarily high strength and elongation, material composed and produced according to the invention is particularly suitable for load-bearing and crash-relevant components of vehicle bodies. For instance, structural components in which a high load-bearing capacity is combined with a high degree of protection and a low weight can be produced from flat steel products according to the invention.

Due to their high energy absorption capacity, flat steel products according to the invention are also suitable for producing armour plates or parts for personal protection. In particular, elements which are worn directly on the body and which serve for protecting against shelling or comparable attacks that occur suddenly can be produced from flat steel products according to the invention.

Due to their reduced weight while at the same time exhibiting good deformability and strength, flat steel products according to the invention are also particularly suitable for processing to create wheels for vehicles, in particular motor vehicles.

Flat steel products composed according to the invention can also be used to produce components for use in the cryogenics field. The advantageous range of properties of cold strip products produced according to the invention is maintained even at low temperatures customary in the cryogenics sector.

It is also conceivable to use steel sheets according to the invention to produce tubes which are intended in particular for the manufacture of high-strength engine parts, such as camshafts or piston rods.

Flat steel products according to the invention can be produced in various ways. Production is conceivable via a conventional converter steel mill or an ELO furnace with subsequent casting using the continuous casting, strip casting or DSC process and with hot rolling carried out after the casting and inline or offline. The hot strips obtained in these ways can if necessary be cold-rolled in a tandem mill, a reversing stand or a Sendzimir mill to form a cold strip.

A Ca treatment improves the castability particularly in the case of analyses according to the invention having high Al contents. Together with alumina (Al₂O₃), Ca forms calcium aluminates which are incorporated in the slag and thus render the alumina harmless. This counteracts the risk of alumina leading to cloggings (accumulations in the immersion tube) which impair the castability. Ca contents of up to 0.015% by weight, in particular up to 0.01% by weight, are therefore permitted in the steel according to the invention, the advantageous effects of the Ca treatment that is optionally carried out being typically expressed in Ca contents of at least 0.0015% by weight.

The hot strip produced from the steel according to the invention can optionally be pickled and also can optionally be surface-coated in a manner known per se. A separate heat treatment of the zinc layer following application is possible in addition.

Alternatively, the hot strip can be cold-rolled in the pickled state, subjected to final annealing by an annealing process carried out in a continuous pass, and then optionally surface-coated (Z, ZE, ZF, ZMg, ZN, ZA, AS, S, thin film, etc.). A separate heat treatment following application of the zinc layer is also possible here in addition.

The hot strip or cold strip according to the invention can then be provided with a special coating which enables use in hot or semi-hot forming processes.

The high resistance of flat steel products according to the invention to delayed cracking can be further improved by a thermal post-treatment. During this post-treatment, zinc-coated material is treated in such a way that an alloying of the zinc layer to the base material is initiated. Material treated in this way exhibits delayed cracking only after considerably extended observation times or may even no longer exhibit delayed cracking.

A typical variant of a method suitable for producing flat steel products according to the invention comprises the following working steps:
A precursor material in the form of slabs or thin slabs is cast from a steel composed according to the invention.
If a reheating is required prior to the subsequently performed hot rolling, particularly when using slabs, the reheating temperature should be no less than 1100° C., in particular should be more than 1150° C. In those cases where the precursor material can be fed directly to the hot rolling in a continuous workflow after the casting (e.g. in a casting-rolling line in which thin slabs are cast and processed to form a hot strip in continuously successive working steps), this may also take place without intermediate reheating in direct use utilising the casting heat. The pass reduction rate during the hot rolling should be in each case at least 10% per pass in order to obtain a hot-rolled flat steel product according to the invention with an optimally composed structure under practical production conditions.
After the heating that may be carried out if necessary, the precursor material is hot-rolled at a final hot rolling temperature of at least 800° C. to form a hot strip.
Thereafter, the hot strip obtained is wound at a coiling temperature of at most 700° C. to form a coil.

Since the hot rolling is finished at a temperature of at least 800° C. and coiling takes place at a comparably low temperature, the positive effect of the carbon and, where present, in particular of the boron contained in the steel according to the invention is fully utilised. In the case of sheets hot-rolled in this range, boron and carbon give rise to higher tensile strength and yield strength values while still maintaining acceptable elongation at break values. As the final hot rolling temperature increases, the tensile strength and yield strength of the hot strip decrease while the elongation values rise. By varying the final rolling temperatures within the framework defined by the invention, the desired properties of the resulting hot flat steel product can thus be influenced in a simple and targeted manner.

In the hot strip produced according to the invention, at least 80%, in particular 90% and more, of the V content and at least 50%, in particular 60% and more, of the Nb content exists in dissolved form. The remaining V or Nb contents exist as precipitates, wherein the proportion of the Nb and V contents bound within the precipitates should be as low as possible. Due to the high proportion of dissolved Nb or V in the hot strip, the desired very fine structure can be reliably generated during the subsequent cold rolling and an annealing treatment that is additionally carried out. In contrast, 60-100% of the Ti content exists as TiC precipitates after the hot rolling. These carbide precipitates not only hinder the cold rolling but also lead to the development of coarse precipitates during a final annealing. During the forming of a steel alloyed with relatively large quantities of Ti, said coarse precipitates form the origin of cracks which render the respective component unusable.

Particularly advantageous mechanical properties of the hot strip produced according to the invention, in particular high yield strengths, are obtained when particularly low coiling temperatures, in particular ranging up to room temperature (approx. 20° C.), are set. By limiting the coiling temperature to values of at most 700° C., in particular less than 700° C., in particular less than 500° C. or room temperature, the risk of grain boundary oxidation is minimised in a manner known per se. Grain boundary oxidation may lead to spalling of the material and as such can make further processing more difficult or even impossible.

The hot strip obtained after coiling can be directly cold-formed or hot-formed into a component.

However, the hot strip according to the invention is also suitable in particular for further processing to a cold strip. To this end, after the coiling and a surface cleaning by pickling that may be carried out if necessary, the hot strip can be cold-rolled to form a cold strip in a manner known per se. The cold rolling grade achieved during such a cold rolling is preferably in the range from 30% to 75% in order reliably to achieve the optimised deformation and strength properties of the finished flat steel product according to the invention.

The cold rolling may be followed by a final annealing, the annealing temperatures of which are preferably at most 880° C., in particular less than 800° C. The choice of annealing temperature ensures the formation of a particularly fine structure, the fine grain size of which usually corresponds at least to ASTM 14 and finer. Here, the invention makes use of the fact that by far the largest part of the Nb and V contents still in the dissolved state in the hot strip, as provided according to the invention, form fine precipitates (VCN, NbCN, etc.) during the final annealing, which largely prevent grain growth during the final annealing process. A particularly fine structure is produced by an annealing temperature that is as low as possible. After the final annealing, the strip obtained therefore reliably has the desired fine grain size of the structure. The final annealing may in this case be carried out in a continuous pass in a continuous annealing furnace.

After the cold rolling and the final annealing, the cold strip obtained may also be subjected to skin-pass rolling in order to further improve the dimensional accuracy and mechanical properties thereof.

As already mentioned, the flat steel product according to the invention, provided as a hot or cold strip for further deformation to form a component, may be provided with a metal protective layer in order to protect it against surface corrosion. To this end, in the case where the flat steel product is deformed as a hot strip directly to form a component, the respectively obtained hot strip or the cold strip obtained after cold rolling of the hot strip may for example be hot-dip aluminised, hot-dip galvanised or electrolytically galvanised.

If necessary, a cleaning and preparation of the strip surface is carried out beforehand by pickling.

If the flat steel product is to be delivered in the blank state, instead of a metal coating it may be oiled to provide temporary protection against surface corrosion.

Table 1 shows the alloys of eight steels E1-E8 according to the invention and fourteen comparative steels V1-V14.

From the steels E1-E8 according to the invention and the comparative steels V1-V14, ingots were produced, were in each case heated to a preheating temperature of approx. 1250° C. and were hot-rolled at a final hot-rolling temperature of approx. 950° C. to form in each case a hot strip having a thickness of approx. 3 mm.

The hot strip obtained in each case was coiled at a coiling temperature of approx. 20° C. (room temperature) to form a coil.

After the coiling, the hot strips were cold-rolled at a cold-rolling grade of in each case approx. 66% to form a cold strip having a thickness of approx. 1 mm.

The resulting cold strips were finally subjected to a final annealing carried out in a continuous pass, during which they were heated for a period of approx. 140 s at a temperature Tₐₙₙₑₐₗ below 890° C. The mechanical properties, the respectively set final annealing temperature Tₐₙₙₑₐₗ and the grain size of the structure are shown in Table 2 for the steels E1-E8 according to the invention and the comparative steels V1-V12.

Cups having a blank/cup diameter ratio β=2.0 (drawing ratio) were drawn from the flat steel products. The cups were subjected to a corrosion test, during which they were exposed without any anti-corrosion coating to a 5% NaCl solution. The days that elapsed up to the time of first onset of delayed cracking on one cup among a group of four cups are indicated in the column “cup holding time” in Table 2.

With the steel sheet samples produced from the steels E1-E8 according to the invention and the comparative steels V1-V12, joining tests were then carried out, during which they were spot-welded in an overlapping manner to a conventional, galvanised, deep-drawn steel (“heterogeneous welding”). The operating range achieved in each case, indicated in kiloamperes kA, and the observed maximum crack length in the region of the welding zone as well as an evaluation of the tendency towards solder brittleness are also shown in Table 2.

The “operating range” of spot welding is understood here to mean the difference between the minimum current Imin required to produce a weld spot and the maximum current Imax beyond which there is the risk that material of the substrate to be welded will spatter away from the surface during the welding process (operating range A=Imax−Imin). Such a spattering is to be avoided since it leads to poorer welded joins. The smaller the operating range, the more accurately the welding process must be carried out. The larger the operating range, the easier and more reliable it is to produce a weld under the conditions prevailing in operational practice. In order to ensure practical processing, therefore, operating ranges A of at least 0.8 kA, in particular at least 1.0 kA, are required for example in the automotive sector for steel materials that are to be welded.

In addition, the operational production of an alloy E9 according to the invention was simulated under laboratory conditions, which alloy, besides iron and unavoidable impurities, contained (in % by weight) 19% Mn, 0.4% C, 1.4% Al, 0.45% Si, 2% Cr and 0.12% V. The cold-rolled steel sheet samples produced from this steel, which were provided with a zinc coating, were subjected to a final annealing at final annealing temperatures Tₐₙₙₑₐₗ of less than 800° C. in the continuous annealing process. After this final annealing, the steel sheet samples had a structure with an extremely fine grain size. They exhibited an extremely high resistance to hydrogen-induced cracking in the cupping test. The steel sheet samples had a yield strength Rp of 560 MPa, a tensile strength Rm of 900 MPa, an elongation at break A of 45% and an n value of 0.35. Galvanised cups (β=2.0) drawn from the steel sheet samples remained crack-free in 5% NaCl solution for a period of three months.

An alloy E10 according to the invention was then likewise produced under laboratory conditions, which alloy, like the alloy E9 described above, contained besides iron and unavoidable impurities (in % by weight) 19% Mn, 0.4% C, 1.4% Al, 0.45% Si, 2% Cr and 0.12% V. In addition, 0.003% by weight boron was added to the alloy E10. It was found that the steel sheet samples obtained, given the same production route, exhibited comparable yield strengths but increased elongation at break values.

In a further test, a steel melt composed according to the alloy E8 was subjected to a Ca treatment. The Ca treatment resulted in a good castability despite the high Al contents and properties that corresponded to the Ca-free steels.

To demonstrate the fact that the high resistance to delayed cracking in galvanised flat steel products made from an alloy according to the invention can be further improved by a thermal post-treatment, cold-rolled steel sheet samples were produced from the alloy E2 according to the invention and were provided with a zinc coating. The samples were then subjected to a thermal post-treatment, during which the zinc-coated material was heated so as to initiate an alloying of the zinc layer to the base material. Cups drawn from the material thus treated exhibited a considerably delayed cracking after considerably extended observations times, or else cracking did not appear at all. The results of the analyses are shown in Table 3.

The tests showed that the considerable minimising of the susceptibility to delayed cracking is achieved when the samples that were composed according to the invention and galvanised are batch-annealed at temperatures from 100 to 450° C. for a period of 1 to 200 hours, preferably 24-48 h, or are heat-treated in a continuous annealing plant at temperatures of 400 to 600° C. for 1 to 500 s, in particular 5-300 s.

The resistance of steels according to the invention to solder brittleness during the welding process is considerably improved over the prior art as a result of the very fine microstructure achieved by adding V and/or Nb and as a result of the partial substitution of Al or Si by Cr which takes place within the limits prescribed according to the invention. During the welding tests using steel sheet samples composed according to the invention, no macroscopic cracks were found during the resistance spot welding.

TABLE 1

| | C | Mn | Al | Si | Cr | P | S | N | V | Nb | Ti | B | Cu | Ni | Ca |
|---|---|---|---|---|---|---|---|---|---|---|---|---|---|---|---|
| E1 | 0.418 | 19.3 | 0.52 | 0.48 | 1.85 | 0.004 | 0.007 | 0.0082 | 0.12 | <0.001 | <0.001 | <0.001 | <0.01 | <0.05 | <0.01 |
| E2 | 0.402 | 18.8 | 1.26 | 0.22 | 2.32 | 0.003 | 0.005 | 0.0046 | <0.001 | 0.05 | <0.001 | <0.001 | <0.01 | <0.05 | <0.01 |
| E3 | 0.389 | 18.8 | 1.16 | 0.21 | 2.91 | 0.003 | 0.006 | 0.0044 | <0.001 | 0.08 | <0.001 | <0.001 | <0.01 | <0.05 | <0.01 |
| E4 | 0.402 | 19.2 | 1.04 | 0.27 | 2.08 | 0.004 | 0.006 | 0.0042 | <0.001 | 0.05 | 0.03 | <0.001 | <0.01 | <0.05 | <0.01 |
| E5 | 0.398 | 19.3 | 1.08 | 0.22 | 1.95 | 0.005 | 0.005 | 0.0036 | 0.12 | <0.001 | <0.001 | <0.001 | 0.53 | <0.05 | <0.01 |
| E6 | 0.394 | 18.7 | 1.03 | 0.18 | 2.04 | 0.005 | 0.006 | 0.0044 | 0.12 | <0.001 | <0.001 | <0.001 | <0.01 | 0.42 | <0.01 |
| E7 | 0.382 | 18.7 | 0.65 | 0.30 | 1.96 | 0.005 | 0.008 | 0.0072 | <0.001 | 0.08 | <0.001 | 0.003 | <0.01 | <0.05 | <0.01 |
| E8 | 0.208 | 22.3 | 1.54 | 0.02 | 2.89 | 0.005 | 0.007 | 0.0062 | <0.001 | 0.08 | <0.001 | <0.001 | <0.01 | <0.05 | <0.01 |
| V1 | 0.592 | 22.5 | <0.01 | 0.17 | 0.27 | 0.043 | 0.007 | 0.0058 | 0.2 | <0.001 | <0.001 | <0.001 | 0.110 | 0.20 | <0.01 |
| V2 | 0.587 | 18.2 | 1.46 | 0.20 | 0.031 | 0.006 | 0.006 | 0.0026 | <0.001 | <0.001 | <0.001 | <0.001 | <0.01 | <0.05 | <0.01 |
| V3 | 0.056 | 25.5 | 0.85 | 0.90 | 0.028 | 0.004 | 0.005 | 0.0020 | <0.001 | <0.001 | <0.001 | <0.001 | <0.01 | <0.05 | <0.01 |
| V4 | 0.062 | 25.4 | 1.80 | 1.75 | 0.024 | 0.003 | 0.005 | 0.0028 | <0.001 | <0.001 | <0.001 | <0.001 | <0.01 | <0.05 | <0.01 |
| V5 | 0.064 | 25.3 | 2.66 | 2.70 | 0.024 | 0.003 | 0.005 | 0.0034 | <0.001 | <0.001 | <0.001 | <0.001 | <0.01 | <0.05 | <0.01 |
| V6 | 0.085 | 25.1 | 2.61 | 2.72 | 0.034 | 0.003 | 0.005 | 0.0038 | 0.20 | <0.001 | <0.001 | <0.001 | <0.01 | <0.05 | <0.01 |
| V7 | 0.193 | 22.3 | 2.65 | 0.21 | 0.020 | 0.038 | 0.012 | 0.0060 | 0.20 | <0.003 | <0.001 | <0.001 | <0.01 | <0.05 | <0.01 |
| V8 | 0.404 | 18.4 | 1.52 | 1.54 | 0.032 | 0.003 | 0.007 | 0.0042 | 0.12 | <0.001 | <0.001 | <0.001 | <0.01 | <0.05 | <0.01 |
| V9 | 0.415 | 19.1 | 1.18 | 0.32 | 0.025 | 0.005 | 0.005 | 0.0050 | 0.12 | <0.001 | <0.001 | <0.001 | <0.01 | <0.05 | <0.01 |
| V10 | 0.402 | 18.8 | 1.05 | 0.32 | 1.02 | 0.003 | 0.005 | 0.0046 | 0.12 | <0.001 | <0.001 | <0.001 | <0.01 | <0.05 | <0.01 |
| V11 | 0.211 | 21.8 | 1.45 | 0.02 | 2.98 | 0.005 | 0.007 | 0.0044 | <0.001 | <0.001 | <0.001 | <0.001 | <0.01 | <0.05 | <0.01 |
| V12 | 0.42 | 19.4 | 1.48 | 0.69 | 3.95 | 0.003 | 0.008 | 0.0052 | <0.001 | 0.07 | <0.001 | <0.001 | <0.001 | <0.001 | <0.01 |
| V13 | 0.08 | 25.0 | 3.72 | 0.11 | 0.031 | 0.003 | 0.006 | 0.0048 | 0.28 | <0.001 | 0.13 | <0.001 | <0.01 | <0.05 | <0.01 |
| V14 | 0.47 | 27.2 | 1.12 | 0.09 | 0.042 | 0.004 | 0.007 | 0.0064 | <0.001 | <0.001 | <0.001 | <0.001 | <0.01 | <0.05 | <0.01 |

As produced in a laboratory, figures given in % by weight, remainder iron and unavoidable impurities

TABLE 2

| | | | | | | | Joining properties of cold strip, | | |
|---|---|---|---|---|---|---|---|---|---|
| | | | | | | | galvanised | | |
| | | | | | | | | Maximum | |
| | | | | | | | | crack | |
| | Yield | Tensile | | | | | Operating | length in | Tendency |
| | strength | strength | Elongation | | Grain size | Cup holding | range for spot | joining | towards |
| | Rp | Rm | at break A | Tₐₙₙₑₐₗ | according | time¹) | welding | plane | solder |
| | [MPa] | [MPa] | [%] | [° C.] | to ASTM | [days] | [kA] | [μm] | brittleness |
| E1 | 503 | 912 | 46 | 800 | 14 | 24 | 1.3 | 0 | NO |
| E2 | 538 | 932 | 45 | 850 | 14 | 33 | 1.2 | 0 | NO |
| E3 | 504 | 928 | 44 | 880 | 14 | 32 | 1.1 | 0 | NO |
| E4 | 520 | 920 | 47 | 830 | 14 | 36 | 1.3 | 0 | NO |
| E5 | 530 | 950 | 49 | 750 | 14 | 28 | 1.2 | 0 | NO |
| E6 | 510 | 900 | 52 | 750 | 14 | 30 | 1.3 | 0 | NO |
| E7 | 550 | 920 | 48 | 830 | 14 | 34 | 1.3 | 0 | NO |
| E8 | 540 | 810 | 42 | 800 | 15 | 37 | 1.1 | 0 | NO |
| V1 | 660 | 980 | 46 | 750 | 14 | 2 | 1.7 | 0 | NO |
| V2 | 448 | 862 | 50 | 800 | 12 | 19 | 1.5 | 100 | YES |
| V3 | 342 | 698 | 47 | 835 | 12 | 17 | 1.4 | 100 | YES |
| V4 | 378 | 699 | 53 | 835 | 12 | >50 | 0.7 | 250 | YES |
| V5 | 437 | 741 | 52 | 835 | 12 | >50 | 0 | 300 | YES |
| V6 | 458 | 741 | 50 | 835 | 15 | >50 | 0 | 0 | NO |
| V7 | 460 | 690 | 39 | 750 | 15 | >50 | 0.6 | 0 | NO |
| V8 | 631 | 994 | 44 | 750 | 15 | 45 | 0.6 | 0 | NO |
| V9 | 540 | 950 | 43 | 750 | 15 | 9 | 1.5 | 0 | NO |
| V10 | 550 | 960 | 43 | 750 | 15 | 10 | 1.5 | 0 | NO |
| V11 | 370 | 720 | 50 | 800 | 12 | 27 | 1.1 | 130 | YES |
| V12 | 509 | 923 | 49 | 900 | 14 | 24 | 0.6 | 0 | NO |
| V13 | 443 | 772 | 47 | 800 | 14 | 32 | 0.4 | 30 | YES |
| V14 | 421 | 820 | 47 | 800 | 12 | 7 | 1.3 | 80 | YES |

¹)Cups β = 2.0 in 5% NaCl solution, ungalvanised

TABLE 3

| | | | Cup holding time in |
|---|---|---|---|
| Steel | Surface | Treatment | 5% NaCl solution |
| E2 | galvanised | — | 33 days |
| E2 | galvanised | 300° C., 36 h | unlimited²) |
| E2 | galvanised | 500° C., 20 s | unlimited²) |

²)Tests stopped after 180 days

1. High-strength, cold-formable steel comprising (in % by weight)
C: 0.1-1.0%,
Mn: 10-25%,
Si: up to 0.5%,
Al: 0.3-2%,
Cr: 1.5-3.5%,
S: <0.03%,
P: <0.08%,
N: <0.1%,
Mo: <2%,
B: <0.01%,
Ni: <8%,
Cu: <5%,
Ca: up to 0.015%,
at least one element from the group “V, Nb” with the following proviso:
Nb: 0.01-0.5%,
V: 0.01-0.5%
and optionally
Ti: 0.01-0.5%
and iron and unavoidable, production-related impurities as the remainder.

2. Steel according to claim 1, wherein the C content thereof is 0.3-0.5% by weight.

3. Steel according to claim 1, wherein the Mn content thereof is 17-22% by weight.

4. Steel according to claim 1, wherein it contains at least 0.2% by weight Si.

5. Steel according to claim 1, wherein the Al content thereof is 0.5-1.5% by weight, in particular 0.5-1.3% by weight.

6. Steel according to claim 1, wherein the Cr content thereof is at least 1.7% by weight, in particular at least 1.8% by weight.

7. Steel according to claim 1, wherein the Cr content thereof is at most 2.5% by weight, in particular at most 2.2% by weight.

8. Steel according to claim 1, wherein the N content thereof is 0.0030-0.0250% by weight.

9. Steel according to claim 1, wherein the Ni content thereof is less than 5% by weight.

10. Steel according to claim 1, wherein the Cu content thereof is less than 3% by weight.

11. Steel according to claim 1, wherein the Ca content thereof is at least 0.0015% by weight.

12. Steel according to claim 1, wherein the tensile strength thereof is at least 800 MPa.

13. Flat steel product produced from a steel composed according to claim 1.

14. Flat steel product according to claim 13, wherein it is coated with a metal protective coating in order to protect against surface corrosion.

15. Flat steel product according to claim 14, wherein the metal protective coating is formed by electrolytic galvanisation, by hot-dip galvanisation, by galvannealed coatings, ZnNi coatings or by hot-dip aluminisation.
